(19) United States
(12) Patent Application Publication
(10) Pub. No.: US 2026/0348848 A1
(43) Pub. Date: Nov. 5, 2026

(54) TECHNIQUES FOR MAPPING TOTAL SOLAR REFLECTANCE TO COATINGS

(71) Applicant: PPG Industries Ohio, Inc., Cleveland, OH (US)

(72) Inventors: Saul Daniel Alvarez Nava, Tecamac (MX); Jose Alberto Olivares Lecona, Mexico City (MX); Sebastien Francois Bernard Houdault, Magdalena Contreras (MX); Juan Francisco Choreno Garcia, San Miguel Zumpango (MX)

(73) Assignee: PPG Industries Ohio, Inc., Cleveland, OH (US)

(21) Appl. No.: 19/125,465

(22) PCT Filed: Oct. 30, 2023
(86) PCT No.: PCT/US2023/078183

§ 371 Date: Apr. 29, 2025

Related U.S. Application Data
(60) Provisional application No. 63/381,812, filed on Nov. 1, 2022.

(51) Int. Cl. G01N 21/55; G01J 3/02; G01J 3/46; G01N 21/25; G01N 21/84

(52) U.S. Cl. CPC G01N 21/55; G01N 21/251; G01N 21/8422; G01J 3/0264; G01J 3/463; G01J 2003/467; G01N 2021/555; G01N 2021/8427; G01N 2201/0616

(57) ABSTRACT

The present disclosure relates generally to coatings and more particularly to techniques for mapping total solar reflectance to coatings. A computer for mapping total solar reflectance to coatings receives, through a computer interface, a set of color coordinates from a coating. The computer system searches, a coating database for one or more coatings that conform with the set of color coordinates. The computer system then retrieves from the coating database, in association with each of the one or more coatings, one or more respective total solar reflectance values for each coating. The computer system then renders, on a computer display, at least one of the one or more coatings and visual information relating to the total solar reflectance for the at least one of the one or more coating.

### FIELD OF TECHNOLOGY

The present disclosure relates generally to coatings and more particularly to techniques for mapping total solar reflectance to coatings.

### BACKGROUND

Modern coatings provide various functions in industry and society. For example, different objects and structures (e.g., machinery, vehicles, structures, etc.) may be coated using paints or other types of coatings to protect components from the elements (e.g., from rust) or to provide aesthetic visual effects. Coatings may absorb or reflect light and solar radiation, depending, for example, on pigments, colorants, or other chemical components of the coatings. Absorption of radiation may impact thermal characteristics of a coating and of an object which is coated. Similarly, color fade, coating oxidation, and other similar attributes may be affected by solar radiation.

There are many opportunities for new systems or methods relating to solar absorption or reflectance of coatings. The subject matter claimed herein is not limited to solutions to any disadvantages or challenges described herein. Rather, background is provided only to illustrate a technology area in which some examples described herein may operate or be practiced.

### BRIEF SUMMARY

The present disclosure may include systems, methods, non-transitory computer readable media, or apparatus associated with techniques for mapping total solar reflectance to coatings.

In one example, the present disclosure includes a computer system for mapping total solar reflectance to coatings. The computer system includes one or more processors and one or more computer-readable media having stored thereon executable instructions that, if executed at the one or more processors, configure the computer system to perform various acts. For example, the computer system may receive, through a computer interface, a set of color coordinates from a coating. Additionally, the computer system searches a coating database for one or more coatings that conform with the set of color coordinates. The computer system retrieves from the coating database, in association with each of the one or more coatings, one or more respective total solar reflectance values for each coating. The computer system then renders, on a computer display, at least one of the one or more coatings and visual information relating to the total solar reflectance for the at least one of the one or more coating.

In another example, the present disclosure includes a computer-implemented method for mapping total solar reflectance to coatings, the computer-implemented method being executed at one or more processors. The method includes receiving, through a computer interface, a set of color coordinates. Additionally, the method includes searching a coating database for one or more coatings that conform with the set of color coordinates. The method then includes retrieving from the coating database, in association with each of the one or more coatings, one or more respective total solar reflectance values for each coating. The method further includes rendering, on a computer display, at least one of the one or more coatings and visual information relating to the total solar reflectance for the at least one of the one or more coating.

In another example, the present disclosure includes a non-transitory computer-readable medium including one or more physical computer-readable storage media having stored thereon computer-executable instructions that, if executed at a processor, cause a computer system to perform a method for mapping total solar reflectance to coatings. The method includes receiving, through a computer interface, a set of color coordinates. Additionally, the method includes searching a coating database for one or more coatings that conform with the set of color coordinates. The method then includes retrieving from the coating database, in association with each of the one or more coatings, one or more respective total solar reflectance values for each coating. The method further includes rendering, on a computer display, at least one of the one or more coatings and visual information relating to the total solar reflectance for the at least one of the one or more coating.

Additional features and advantages of exemplary implementations will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above recited and other advantages and features can be obtained, a more particular description briefly described above will be rendered by reference to specific embodiments thereof, which are illustrated in the appended drawings. Understanding that these drawings depict only typical embodiments and are not therefore to be considered to be limiting of its scope, the means for mapping total solar reflectance to coatings will be described and explained with additional specificity and detail through the use of the accompanying drawings in which:

FIG. 1 illustrates an example of a scheme that supports techniques for mapping total solar reflectance to coatings, in accordance with aspects of the present disclosure.

FIG. 2 illustrates an example of techniques for mapping total solar reflectance to coatings, in accordance with aspects of the present disclosure.

FIG. 3A illustrates an example of a heat mapping scheme that supports techniques for mapping total solar reflectance to coatings, in accordance with aspects of the present disclosure.

FIG. 3B illustrates another example of a heat mapping scheme that supports techniques for mapping total solar reflectance to coatings, in accordance with aspects of the present disclosure.

FIG. 4 illustrates an example of an operating scheme that supports techniques for mapping total solar reflectance to coatings, in accordance with aspects of the present disclosure.

FIG. 5 illustrates an example of a system that supports techniques for mapping total solar reflectance to coatings, in accordance with aspects of the present disclosure.

FIG. 6 illustrates an example of a method flow that supports techniques for mapping total solar reflectance to coatings, in accordance with aspects of the present disclosure.

FIG. 7 is a picture of an asbestos cement wall colored with different coating samples which will be used to predict values with the computer system of the instant invention.

FIG. 8 is the picture of FIG. 7 indicating the Color coordinates measured with a Konica Minolta colorimeter model CM-26D.

FIG. 9 is the picture of FIG. 7 indicating the Color coordinates measured with Color Picker Android app.

FIG. 10 illustrates a thermal image of the picture of FIG. 7 obtained with a Jenoptik thermal imaging camera, VarioCam Model.

FIG. 11 illustrates a prediction image of the thermal image of FIG. 10 using the computer system of the instant invention.

FIG. 12 is a picture of a building on which color and thermal conditions will be predicted using the computer system of the instant invention.

FIG. 13 is a thermal image of the building of FIG. 12 obtained with a Jenoptik thermal imaging camera, VarioCam Model.

FIG. 14 is a picture of the building of FIG. 12 showing color measurements on three zones of the wall predicted with the computer system of the instant invention.

### DETAILED DESCRIPTION

The present disclosure relates generally to coatings and more particularly to techniques for mapping total solar reflectance to coatings. In one example, the present disclosure includes a computer for mapping total solar reflectance to coatings. The computer system may include executable instructions, which, if executed at a processor, configure the computer system to receive, through a computer interface, a set of color coordinates (e.g., CIELab color coordinates, including a lightness value (L*), a red/green value (a*), and a yellow/blue value (b*)) from a coating. The computer system may search a coating database for one or more coatings that conform with the set of color coordinates. The computer system may render, on a computer display, at least one of the one or more coatings. Implementing aspects of the present disclosure may enable visualization of reflectance or thermal properties of coatings, which may lead to an increased accuracy or efficiency of coating selection.

For example, a computer system may be implemented which communicates with (e.g., via a computer interface) cameras or sensors configured to take images of or otherwise measure properties of coatings, such as set of color coordinates. The color coordinates may be within any known color space (e.g., RGB, CIElab, etc.) and may be derived from the camera and/or sensor information. For example, there are a variety of different known methods for converting spectrophotometric data into a number of different color spaces. The cameras or sensors may take measurements (e.g., color measurements, images, etc.) of coatings on an object and may send the measurements to the computer system. The computer system may receive the measurements, including a set of color coordinates and may use the measurements to search a color database for a total solar reflectance of the associated coatings on the object. As used herein, a “total solar reflectance (TSR)” is a measured and/or calculated value that indicates the ratio of total solar energy reflected from a particular surface and the total incident solar energy on the particular surface. A total solar reflectance of a given material is typically measured using a pyranometer, a spectrophotometer, or a reflectometer. Various methods for calculating a TSR from these measurements can be used, including averaging reflectance values between the various angles of measurements. Additionally, as used herein the “total solar reflectance” is defined mathematically below in equation 1. The computer system may also calculate surface temperatures or heat maps for the object based on the received measurements and information available in coating database. The computer system may search a coating database or other databases for coatings that exhibit similar properties (e.g., color coordinate or reflectance characteristics) as the coatings on the object and may display the resulting coatings to a user of the computer system. In some implementations, the measurements may also include environmental measurements such as temperature, atmospheric pressure, geographic location, etc., such that the computer system uses any available data to calculate surface temperatures or heat maps.

In some examples, the computer system may include a head-mounted display (e.g., an augmented reality headset or a virtual reality headset). In such examples, sensors or cameras may be integrated into the head-mounted display. In such examples, the results of searching the database may be displayed such that the coatings are overlaid on the object.

Various aspects of the present disclosure may be implemented to realize one or more potential advantages. For example, implementing aspects of the present disclosure may enable visualization of coatings, including visual, reflectance, or thermal properties associated with the coatings. Such visualization may allow for a more efficient or accurate selection of coatings based on different visual, reflectance, or thermal properties, such as for energy-saving or cost-saving measures.

Aspects of the present disclosure are further described herein with respect to a reflectance, heat mapping, or operating schemes. Aspects of the present disclosure are also described herein with respect to systems and a method flow.

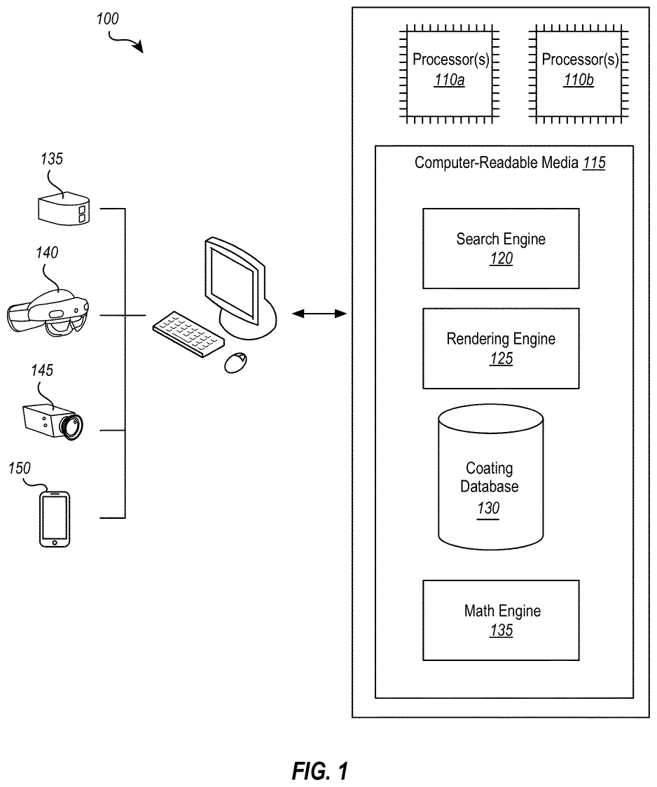

FIG. 1 illustrates an example of a scheme 100 that supports techniques for mapping total solar reflectance to coatings, in accordance with aspects of the present disclosure. The scheme 100 may include a computer system 105, including one or more processors (e.g., a processors 110a, a processor 110b, etc.) and computer-readable media 115. The computer-readable media 115 may include executable instructions which, if executed at the one or more processors, configure the computer system 105 to perform various aspects of the present disclosure. The executable instructions may include a search engine 120 and a render engine 125. The computer system 105 may also include a coating database 130 or a network connection for accessing one or more external databases. The scheme 100 may also include a sensor system 135, a head-mounted display 140, a camera 145, or a cellular phone 150.

One or more of the sensor system 135, the head-mounted display 140, or the camera 145, or a cellular phone 150 may take images or measurements (e.g., color measurements) of an object that has one or more coatings applied. For example, the object may be a terrain vehicle, marine vehicle, or aerial vehicle, a building or structure, a piece of machinery, etc. that has coated portions (e.g., such that the coating is formulated for an automotive, marine, architectural, or aerospace industry). The computer system 105 may receive measurement data (e.g., a set of color coordinates) and may use the measurement data to search or otherwise determine (e.g., at the search engine 120) a total solar reflectance or a range of total solar reflectance values for the object or for each coating. Accordingly, the computer system 105 may receive weather information or temperature data from one or more sensors (e.g., the sensor system 135, the head-mounted display 140, the camera 145, or the cellular phone 150) or from databases (e.g., The Weather Channel) and may calculate total solar reflectance and other values based on the weather information or temperature data.

The computer system 105 may search the coating database 130 for coatings which conform with or are otherwise similar to parameters of the measured coatings. As used herein a coating “conforms” with the set of color coordinates when the coating coordinates and/or the total solar reflectance value are within one or more threshold values of the set of color coordinates. For example, a user may be able to define a threshold for the set of color coordinates based upon any of a number of known color matching algorithms, including but not limited to Kubelka-Munk. In an additional or alternative threshold, the system can identify “conforming” coatings by first searching the coating database for all coatings within a threshold value of the set of color coordinates and then returning a specified number of coatings with the nearest matching color coordinates. The nearest matching color coordinates may be determined using distance formulas between the respective color coordinates within a given color space. Additionally, in some examples, the database component 535 may access, within a location database, information relating to temperature data at a geographic location received via the data receiver 505. For example, the computer system 105 may search for coatings that have a same set of color coordinates or a same total solar reflectance as the measured coatings. In some implementations, the computer system 105 may also search for coatings which have similar but different parameters. In some examples, the computer system 105 may also search other databases for information relating to the measured coatings or the climate or other environmental parameters associated with a geographic location at which the object is located (e.g., The Weather Channel).

The computer system 105 may render (e.g., at the render engine 125) coatings identified in the database on a computer display (e.g., such as the head-mounted display 140 or on the cellular phone 150 or on the computer system 105). For example, the computer system 105 may display information, such as color coordinates or solar reflectance, for the identified coatings. In some examples, the computer system 105 may overlay an image of the coatings on the object (e.g., if using the head-mounted display 140), which may lead to an increased efficiency or accuracy of coating selection or application.

In some examples, the computer system 105 may also compute (e.g., at the math engine 132) and render a predicted surface temperature or a heat map of the object based on the total solar reflectance and other environmental conditions. Accordingly, the computer system 105 may receive weather information or temperature data from one or more sensors (e.g., the sensor system 135, the head-mounted display 140, or the camera 145) or from databases (e.g. The Weather Channel) and may render heat maps and other values based on the weather information or temperature data. In such examples, the computer system 105 may also display the surface temperature or heat map on the computer display. Implementing aspects of the scheme 100 may enable visualization of reflectance or thermal characteristics associated with coatings, which may lead to an increased efficiency or accuracy of coating selection or application.

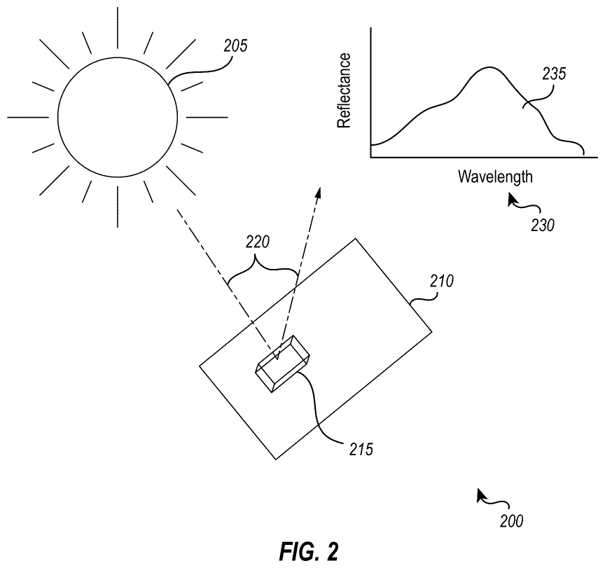

FIG. 2 illustrates an example of a reflectance scheme 200 that supports techniques for mapping total solar reflectance to coatings, in accordance with aspects of the present disclosure. In some examples, the reflectance scheme 200 may be associated with aspects of a scheme 100, as described with reference to FIG. 1. For example, reflectance calculations may be made based on the reflectance scheme 200. The reflectance scheme 200 may include a solar light source 205, a surface 210. The surface 210 may have an area 215 on which the solar light source 205 reflects light along a path 220. The reflection of the light along the path 220 may be illustrated by a graph 230. The graph 230 illustrates a plot of reflectance vs wavelength. That is, the graph 230 shows reflectance 235 of a surface (e.g., of a coating) for a range of wavelength values. The reflectance may be based on the relative distance of the solar light source 205 to the surface 210, a relative angle of the path 220 to the surface 210, air or weather conditions, temperature, or similar factors.

The TSR values may be calculated according to Equation 1:

$$TSR = {\int }_{350}^{2500} \frac{R ( x ) I ( x ) dx}{{\int }_{350}^{2500} I ( x ) dx}$$

Equation 1 illustrates that total solar reflectance (TSR) is equal to an integral over the wavelength (e.g., 350 nm to 2500 nm) of the reflectance (R(x)) multiplied by the solar spectrum (I(x)) divided by the integral of the solar spectrum over the wavelength. The reflectance (R(x)) may be measured using a spectrophotometer. The solar spectrum may be based on a geographic location of the system or may be representative of a global average. The solar spectrum may also be available within various known charts or data tables (e.g., the Frauenhofer Spectrum). In some examples, the total solar reflectance may be based on measuring reflectance of a coating over a range of wavelengths or over a period of time (e.g., over several minutes, over an hour, over a day, etc.). Similarly, the total solar reflectance may be based on temperature, climate, or geographic location (e.g., due to a relative angle of solar radiation hitting the object). Accordingly, in some situations, a sensor system may take measurements across a large time interval such as over several hours or over a day. The sensor system may compute an average of measurements taken over the time interval or may compute a set of average values of a number of smaller time intervals. Based on Equation 1, a system may calculate a total solar reflectance value associated with one or more coatings on an object and may use the total solar reflectance as an input parameter to search a coating database for coatings with a similar total solar reflectance value. Implementing aspects of the reflectance scheme 200 may enable visualization of reflectance or thermal characteristics associated with coatings, which may lead to an increased efficiency or accuracy of coating selection or application.

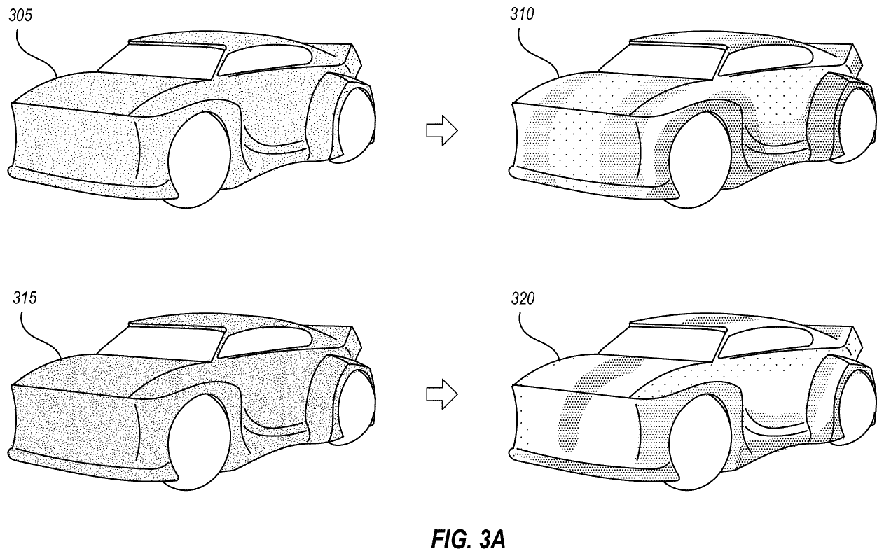

FIGS. 3A and 3B illustrate examples of heat mapping schemes that supports techniques for mapping total solar reflectance to coatings, in accordance with aspects of the present disclosure. In some examples, the heat mapping scheme may be implemented by or otherwise associated with aspects of a scheme 100 or a reflectance scheme 200, as described with reference to FIGS. 1 and 2. For example, the heat mapping scheme 300 may be associated with heat maps generated by a computer system 105, as described with reference to FIG. 1. The heat mapping scheme 300 includes vehicles with a first coating 305 and a second coating 315, which are associated with a heat map 310 and a heat map 320, respectively. FIG. 3B illustrates exemplary heat mapping schemes 325, 330, 335, 340 applied to houses.

The heat map 310 and the heat map 320 may represent a surface temperature of the vehicles. Similarly, heat maps 325, 330, 335, 340 may represent a surface temperature of the houses. For example, solar radiation may be reflected or absorbed by the surface of the vehicles (e.g., by the coating 305 or the coating 315) or houses. The reflection or absorption of the solar radiation may release heat (e.g., by heating up the surface or by the reflected radiation), which may raise the temperature of the surface. Different portions of the vehicle or house may reach different temperatures based on the angle at which solar radiation hits a portion or characteristics of a coating on the portion. For example, the coating 305 and the coating 315 may be similar in color or visual aesthetic. However, the heat map 310 may be different from the heat map 320 due to, for example, chemical components in the coating 305 and the coating 315, weathering, slight differences in color or visual aesthetic, different geographic origins, etc.

A system may be used to visualize the heat map 310 and the heat map 320 based on measurements of the coating 305 and the coating 315. For example, a system may measure a set of color coordinates associated with the coating 305 and may search a total solar reflectance associated with the coating 305. In some examples, the system may search a coating database for coatings which have the same set of color coordinates or total solar reflectance and display the results to a user. The coating database may link parameters like warm colors or cold colors to the coatings within the database such that the user can filter coatings by physical temperature characteristics associated with the coatings. In some examples, the system may also calculate a predicted surface temperature associated with the coating 305. For example, the system may receive an indication of a geographic location and search a location database for information relating to temperature data or climate data at the geographic location and may use the resulting information to calculate a predicted surface temperature for the coating 305 at the location. The system may use the predicted surface temperature to calculate and render the heat map 310 for visualization. Accordingly, a user may select coatings or coating characteristics based on the heat map and other information relating to the coating 305. Implementing aspects of the heat mapping scheme 300 may enable visualization of reflectance or thermal characteristics associated with coatings, which may lead to an increased efficiency or accuracy of coating selection or application.

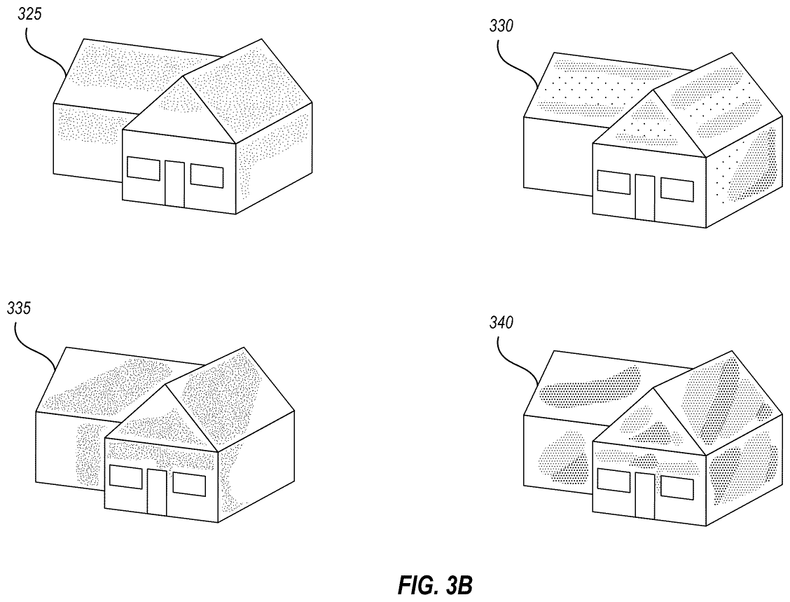

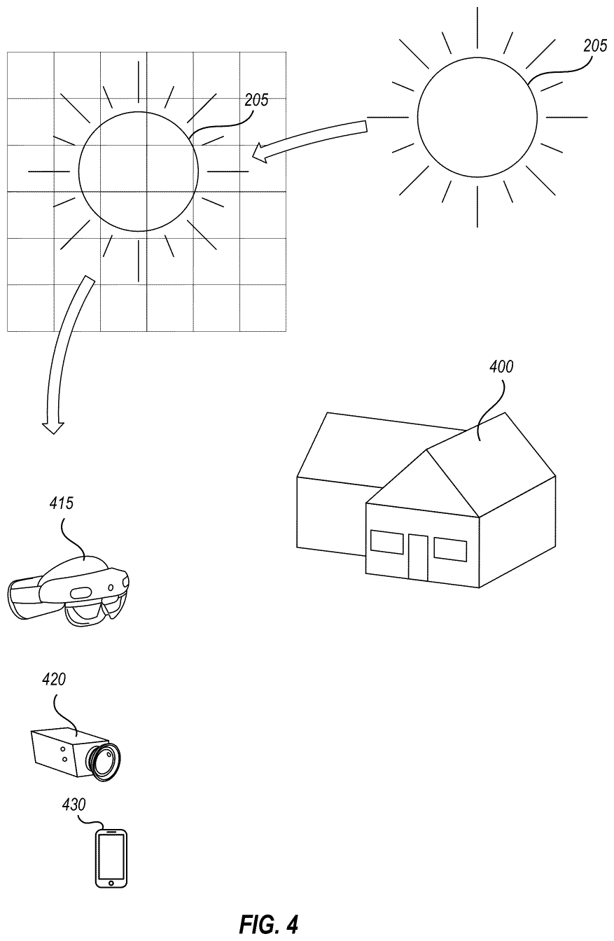

FIG. 4 illustrates an example of an operating scheme 400 that supports techniques for mapping total solar reflectance to coatings, in accordance with various aspects of the present disclosure. In some examples, the operating scheme 400 may be implemented by or otherwise associated with aspects of a scheme 100, a reflectance scheme 200, or a heat mapping scheme 300, as described with reference to FIGS. 1-3. For example, the operating scheme 400 may include sensor systems such as a head-mounted display 415 or a camera 420 or smart cellular phone 430, which may be examples of a head-mounted display 140 or a camera 145, or smart cellular phone 150, respectively, as described with reference to FIG. 1. The operating scheme 400 may also include a structure 425 in a geographic location such that light or radiation is reflecting off the structure 425 from a solar light source 205. In some examples, the operating scheme 400 may also include a computer system, including processors, computer-readable media, etc.

A sensor system (e.g., the head-mounted display 415 or the camera 420) may take measurements of coatings associated with the structure 425. For example, the sensor system may measure a set of color coordinates associated with the coatings on the structure 425.

The sensor system may transmit or otherwise communicate the measurements to a system (e.g., a computer system 105, as described with reference to FIG. 1). The system may search for a total solar reflectance for each coating on the structure 425. In some examples, the system may also calculate or otherwise determine a predicted surface temperature or a heat map for portions of the structure 425. The surface temperature may be based on temperature measurements, geographic location, solar radiation spectrum data, the set of color coordinates, or other similar factors. In some examples, the system may calculate a predicted surface temperature for different time periods such as for different times during a day or different seasons during the year or for different geographic locations. Predicted surface temperature or heat map may be dependent on a geographic location of the structure 425 or on a location of the solar light source 205 (e.g., due to difference in relative angles of light reflected off of the structure 425). For example, reflectance measurements may be different if the solar light source 205 is at a position 410a than if the solar light source 205 is at a position 410b.

The system may search databases for coatings with similar reflectance and color properties (e.g., similar total solar reflectance values or color coordinates) and determine predicted surface temperatures or heat maps for resulting coatings. The system may display, to a user, information relating to the resulting coatings, heat maps, predicted surface temperatures, reflectance values, or similar information. Implementing aspects of the operating scheme 400 may enable visualization of reflectance or thermal characteristics associated with coatings, which may lead to an increased efficiency or accuracy of coating selection or application.

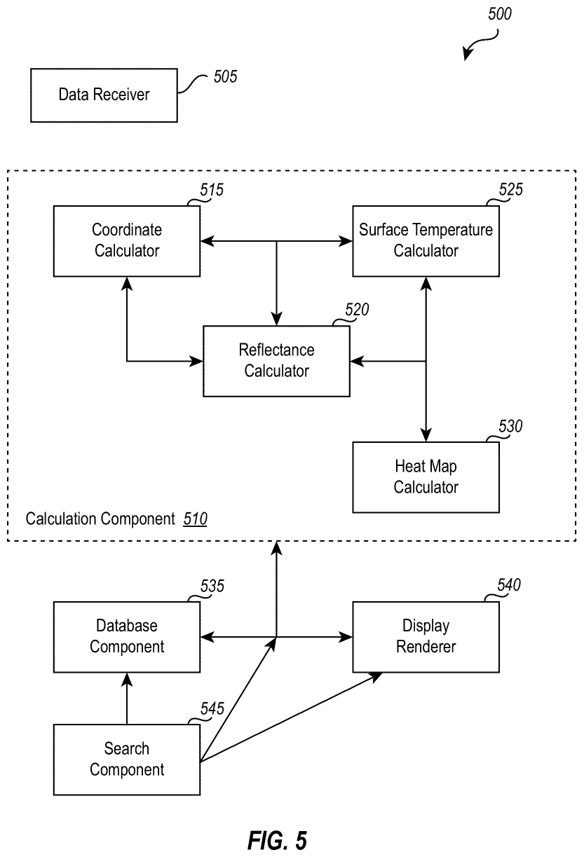

FIG. 5 illustrates an example of a system 500 that supports techniques for mapping total solar reflectance to coatings, in accordance with various aspects of the present disclosure. In some examples, the system 500 may implement or otherwise be associated with aspects of a scheme 100, a reflectance scheme 200, a heat mapping scheme 300, or an operating scheme 400, as described with reference to FIGS. 1-4. For example, the system 500 may be implemented by one or more processors or computer-readable media, as described herein. The system 500 may include a data receiver 505, which may include a computer interface (e.g., a sensor interface, a camera, a smart cellular phone, a human or data input interface, a wireless interface, a wired network interface, etc.). The system 500 may also include a calculation component 510, which may include a coordinate calculator 515, a reflectance calculator 520, a surface temperature calculator 525, and a heat map calculator 530. The system 500 may also include a database component 535, a display renderer 540, and a search component 545. The calculation component 510 may be an example of a math engine 132, as described with reference to FIG. 1. Similarly, the display renderer 540 may be an example of a render engine 125 and the database component 535 may be an example of a coating database 130 or a means of accessing a coating database 130, as described with reference to FIG. 1. The components of the system 500 may communicate which each other as illustrated or along other channels. In some examples, the system 500 may include additional components or components may be removed or altered. The system 500 may be an example of means for performing methods or functions of the present disclosure, as described herein.

The data receiver 505 may receive, through a computer interface, a set of color coordinates or from a coating. In some examples, the data receiver 505 may receive, through the computer interface, a geographic location, a current weather condition including temperature data of the geographic location where a physical object is located, an image of the physical object, or information about a first coating that is currently on the physical object. The data receiver 505 may receive the foregoing data from, for example, an input device such as a camera, a smart phone, a sensor or sensor array, or components associated with a head-mounted display such as an augmented reality or virtual reality device, or a human or data input interface.

The coordinate calculator 515 or the reflectance calculator 520 may calculate, from the solar reflection spectrum measured from a material, a total solar reflectance value and/or a set of color coordinates. In some implementations, the reflectance calculator 520 may calculate a first total solar reflectance based on temperature or coating information received via the data receiver 505. The search component 545 may search the database component 535 for coatings which conform with set of color coordinates of the measured coating and rendering a total solar reflectance or a range of total solar reflectance values for the object or for each coating. In some implementations, the database component 535 may search the coating database for the first total solar reflectance value associated with a first coating, as received via the data receiver 505. Similarly, in some examples, the database component 535 may search the coating database for one or more coatings that match or are in a threshold distance from the total solar reflectance. The database component 535 may then return the color coordinates of each of the one or more coatings. As such, a user may select coatings based upon a desired solar reflectance value.

In some examples, the surface temperature calculator 525 may calculate a predicted surface temperature of the physical object based on the first total solar reflectance value associated with the first coating and temperature data at the geographic location, as received via the data receiver 505. In some examples, the heat map calculator 530 may calculate a heat map of the physical object based on the first total solar reflectance value associated with the first coating and a current weather condition, as received via the data receiver 505.

The display renderer 540 may render, on a computer display, at least one of the one or more coatings. In some examples, the display renderer 540 may render a heat map of a first coating selected from one or more coatings on physical object, in which the heat map indicates a predicted surface temperature of the physical object, as calculated at the surface temperature calculator 525 based on a first total solar reflectance associated with the first coating, as retrieved at the database component 535. In some implementations, the computer display may include a head-mounted display, or other visualization display such that the display renderer 540 renders the heat map or other information such that it is overlaid on an image of the physical object. Implementing aspects of the system 500 may enable visualization of reflectance or thermal characteristics associated with coatings, which may lead to an increased efficiency or accuracy of coating selection or application.

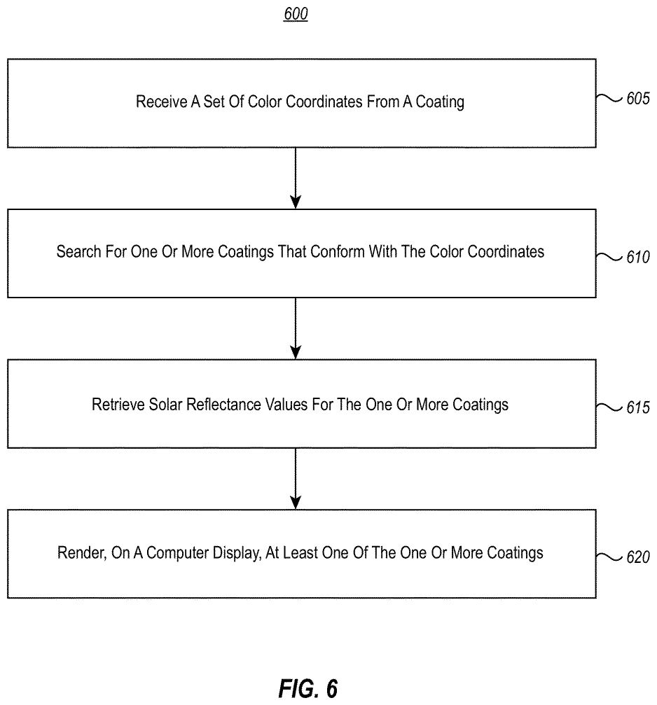

FIG. 6 illustrates an example of a method flow 600 that supports techniques for mapping total solar reflectance to coatings, in accordance with various aspects of the present disclosure. In some examples, the method flow may be implemented by or otherwise associated with aspects of a scheme 100, a reflectance scheme 200, a heat mapping scheme 300, an operating scheme 400, or a system 500, as described with reference to FIGS. 1-5. For example, the method flow 600 may be implemented by a system having one or more processors and computer-readable media having stored thereon executable instructions that, if executed at the one or more processors, configure the system to perform the steps of the method flow 600. In addition, or as an alternative, to the example illustrated in FIG. 6, the method flow 600 may be performed in a different order than illustrated or steps may be added, removed, or changed.

At 605, the method flow 600 may include receiving a set of color coordinates from a coating. Step 605 comprises, receiving, through a computer interface, a set of color coordinates from a coating. In some implementations, the computer interface may include a human interface or a sensor interface. In some examples, the coating may be configured for use within one or more of an automotive industry, an architectural industry, or an aerospace industry.

At 610, the method flow 600 may include searching for one or more coatings that conform with the color coordinates. Act 610 comprises searching a coating database for one or more coatings that conform with the set of color coordinates. For example, the computer system 105 can search the coating database 130 using the set of color coordinates. The search may comprise performing a nearest match calculation to identify one or more coatings within the coating database 130 that comprise the nearest color match to the set of color coordinates.

At 615, the method flow 600 may include retrieving solar reflectance values from the one or more coatings. Act 615 comprises retrieving from the coating database, in association with each of the one or more coatings, one or more respective total solar reflectance values for each coating. The one or more respective reflectance values may be stored within the coating database 130 in association with each coating. As used herein, being stored “in association” within a coating means that the solar reflectance value is linked to the coating within the database.

At 620, the method flow 600 may include rendering, on a computer display, at least one of the one or more coatings and visual information relating to the total solar reflectance for the at least one of the one or more coatings. In some examples, rendering visual information for the at least one of the one or more coatings may include rendering the heat map of the first coating selected from the one or more coatings on a physical object, wherein the heat map indicates the predicted surface temperature of the physical object based on the first total solar reflectance value associated with the first coating. In some examples, rendering visual information may comprise displaying coating coordinates, solar reflectance values, and various other data related to the coating. In some implementations, the computer display may include a head-mounted display or other visualization display such that steps associated with the method flow 600 are performed at components associated with the head-mounted display or other visualization display and the heat map is overlaid on an image of the physical object. Implementing aspects of the method flow 600 may enable visualization of reflectance or thermal characteristics associated with coatings, which may lead to an increased efficiency or accuracy of coating selection or application.

### EXAMPLES

### Example 1. Measure of Color Coordinates on Coating Samples

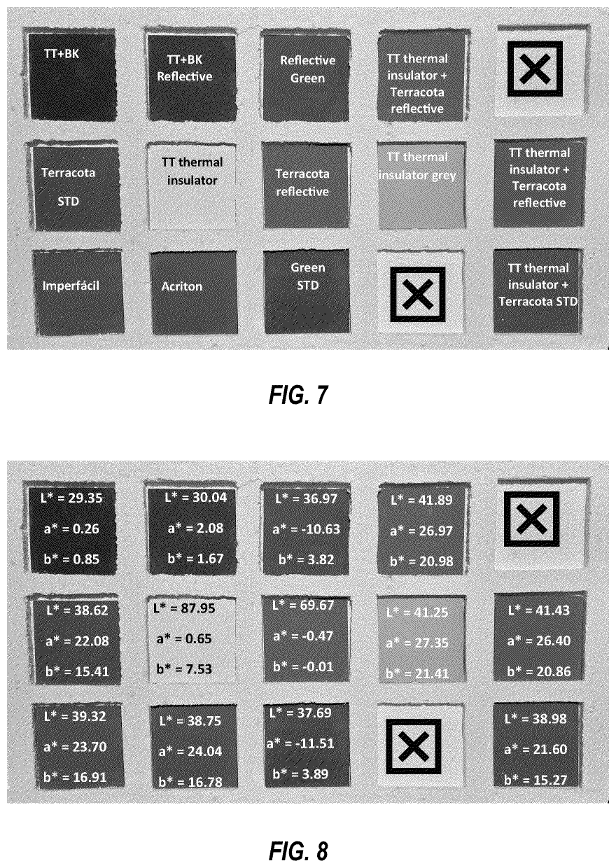

In one example, several colored coatings were applied on an asbestos cement wall as illustrated in FIG. 7.

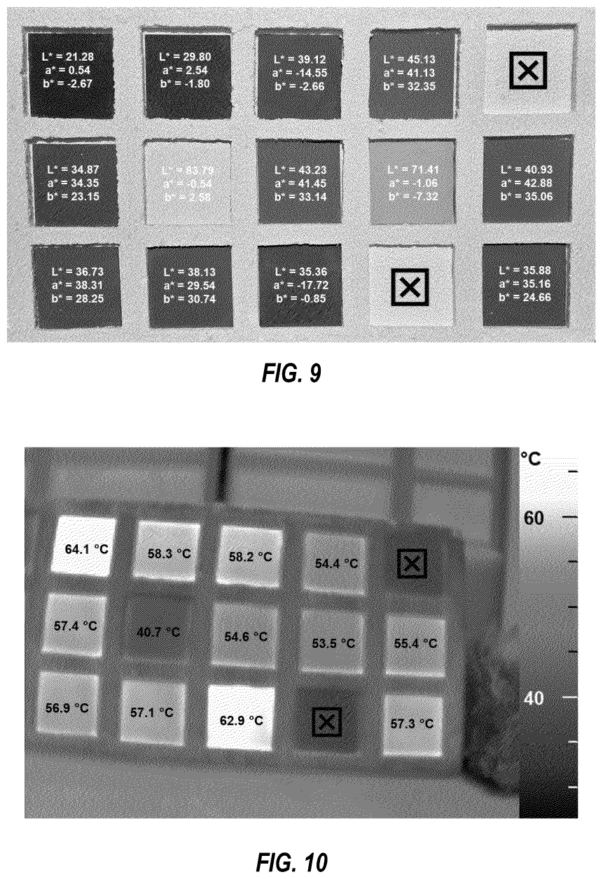

The color properties (L*a*b*) for each coating were measured using two different alternatives: FIG. 8 shows color coordinates measured with a colorimeter (Konica Minolta model CM-26D) and FIG. 9 shows color coordinates measured with a cellphone app (Color Picker).

Upon review of the color measurements obtained with the colorimeter and the cellphone app, it is noticed that there is a minor difference between (L*a*b*) values for the same sample. However, these differences are not perceived by the human eye.

### Example 2. Measure of Temperature on Coating Samples

The coating samples illustrated in FIG. 7 were exposed to solar irradiance. A thermal image was taken using a Jenoptik thermal imaging camera, VarioCam Model. The temperatures associated with each coating sample as disclosed in FIG. 10. The solar irradiance in this test is equal to 826.76 W/m², the photo was taken on Aug. 7, 2023, at 11:15 a.m.

### Example 3. Estimation of the Thermal Behavior of Each Coating Sample

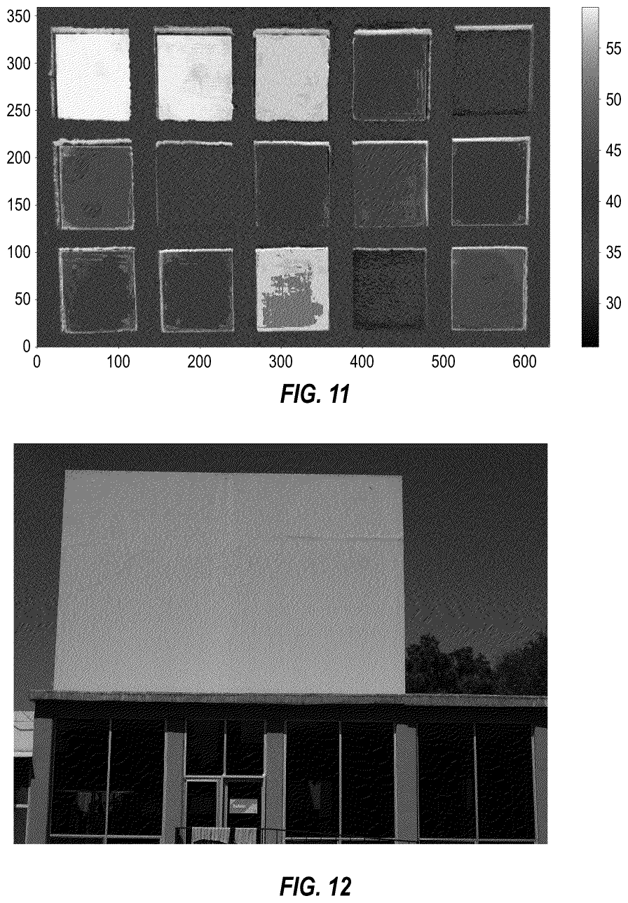

The data obtained in example 1 for color properties (L*a*b*), were used in a system 500 including a calculation component 510, a coordinate calculator 515, a reflectance calculator 520, a surface temperature calculator 525, and a heat map calculator 530. A prediction of temperature for each coating considering a total solar reflectance of 826.76 W/m² was obtained and the results are illustrated in FIG. 11.

The results of temperature obtained by the computer system of the instant invention are similar to those measured in real conditions.

### Example 4. Simulation of Temperature on Walls

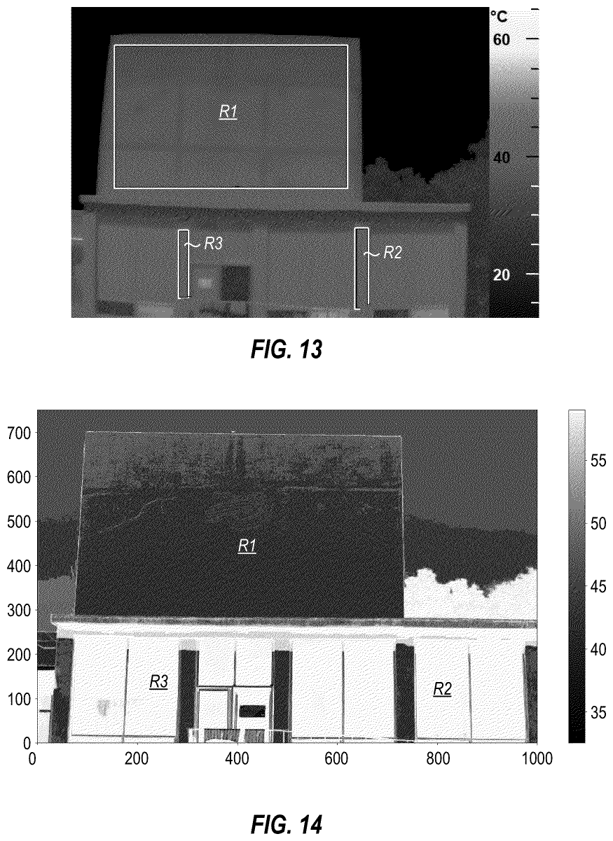

A thermographic image (FIG. 13) was taken using a Jenoptik thermal imaging camera, VarioCam Model on a wall of the building illustrated in FIG. 12. The solar irradiance in this test is equal to 913.38 W/m². Three Regions of Interest (R1, R2 and R3) were identified in the thermographic image to compare the real temperature on the wall in accordance with the temperature scale on the right side of FIG. 12 with the temperature simulated with the computer system of the instant invention. The results are disclosed in Table A below:

TABLE A

| Region of | | | | Standard |
|---|---|---|---|---|
| interest | Avg | Min | Max | deviation |
| R1 | 37.0 °C | 33.0 °C | 41.0 °C | 1.61 °C |
| R2 | 40.7 °C | 36.0 °C | 43.7 °C | 1.03 °C |
| R3 | 41.7 °C | 40.1 °C | 42.8 °C | 0.45 °C |

The simulated temperature results of Table A are similar to those indicated in the temperature scale on the right side of FIG. 12.

### Example 5. Simulation of Color Coordinates on Walls

The picture of FIG. 12 was used to simulate the color properties (L*a*b*) in the three Regions of Interest (R1, R2 and R3) illustrated in FIG. 14. The simulated results obtained with the computer system of the instant invention are disclosed in Table B below:

TABLE B

| Region of interest | Avg | L | a | b |
|---|---|---|---|---|
| R1 | 43.6 °C | 69.74 | 7.53 | 21.51 |
| R2 | 42.2 °C | 50.73 | 29.12 | 38.20 |
| R3 | 42.3 °C | 51.58 | 29.33 | 36.37 |

Although the subject matter is described herein using language specific to structural features or methodological acts, it is understood that the subject matter defined in the appended claims is not limited to any described features or acts, or the order of the acts described herein. Rather, the described features and acts are disclosed as example forms of implementing the claims.

The present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the present disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The present disclosure may include implementations within network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The present disclosure may include implementations within a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present disclosure may include other forms or examples without departing from its spirit or essential characteristics. The described examples are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1-27. (canceled)

28. A computer system for mapping total solar reflectance to coatings, comprising:
one or more processors; and
one or more computer-readable media having stored thereon executable instructions that when executed by the one or more processors configure the computer system to:
receive, through a computer interface, a set of color coordinates from a coating;
search a coating database for one or more coatings that conform with the set of color coordinates;
retrieve from the coating database, in association with each of the one or more coatings, one or more respective total solar reflectance values for each coating; and
render, on a computer display, at least one of the one or more coatings and visual information relating to the total solar reflectance for the at least one of the one or more coatings.

29. The computer system of claim 28, wherein the coating is formulated for use within one or more of an automotive industry, a marine industry, an architectural industry, or an aerospace industry.

30. The computer system of claim 28, wherein the computer interface comprises a human interface.

31. The computer system of claim 28, wherein the computer interface comprises a sensor interface.

32. The computer system of claim 28, wherein the executable instructions to render, on the computer display, at least one of the one or more coatings, further include instructions that are executable to configure the computer system to:
render a heat map of a first coating selected from the one or more coatings on a physical object, wherein the heat map indicates a predicted surface temperature of the physical object based at least in part on a first total solar reflectance value associated with the first coating.

33. The computer system of claim 32, wherein the executable instructions further include instructions that are executable to configure the computer system to:
receive, through the computer interface, a geographic location;
access, within a location database, information relating to temperature data at the geographic location; and
calculate the predicted surface temperature of the physical object based at least in part on the first total solar reflectance value associated with the first coating and the temperature data at the geographic location.

34. The computer system of claim 32, wherein the executable instructions further include instructions that are executable to configure the computer system to:
receive, through the computer interface, a current weather condition including temperature data of a geographic location where the physical object is located;
receive, through the computer interface, information about the first coating that is currently on the physical object;
retrieve from the coating database a first total solar reflectance value for the first coating; and
calculate the heat map of the physical object based at least in part on the first total solar reflectance value associated with the first coating and the current weather condition.

35. The computer system of claim 28, wherein the computer display comprises a head-mounted display.

36. The computer system of claim 35, wherein the executable instructions to render, on the computer display, the one or more coatings, further include instructions that are executable to configure the computer system to:
receive, through a camera integrated into the head-mounted display, an image of a physical object;
receive, through the computer interface, a current weather condition including temperature data of a geographic location where the physical object is located;
receive, through the computer interface, information about a first coating that is currently on the physical object;
retrieve from the coating database a first total solar reflectance value for the first coating;
calculate a heat map of the physical object based at least in part on the first total solar reflectance value associated with the first coating and a current temperature; and
render, within the head-mounted display, the heat map of the first coating selected from the one or more coatings on a physical object, wherein the heat map is overlaid on the image of the physical object.

37. The computer system of claim 36, wherein the current temperature of a surface of the physical object is received through a sensor integrated within the head-mounted display.

38. A computer-implemented method for mapping total solar reflectance to coatings, the computer-implemented method executed on one or more processors, the computer-implemented method comprising:
receiving, through a computer interface, a set of color coordinates from a coating;
searching a coating database for one or more coatings that conform with the set of color coordinates;
retrieving from the coating database in association with each of the one or more coatings one or more respective total solar reflectance values for each coating; and
rendering, on a computer display, at least one of the one or more coatings and visual information relating to the total solar reflectance for the at least one of the one or more coatings.

39. The computer-implemented method of claim 38, wherein the total solar reflectance value comprises a range of total solar reflectance values.

40. The computer-implemented method of claim 38, wherein the computer interface comprises a human interface.

41. The computer-implemented method of claim 38, wherein the computer interface comprises a sensor interface.

42. The computer-implemented method of claim 38, wherein rendering, on the computer display, at least one of the one or more coatings further comprises:
rendering a heat map of a first coating selected from the one or more coatings on a physical object, wherein the heat map indicates a predicted surface temperature of the physical object based at least in part on a first total solar reflectance value associated with the first coating.

43. The computer-implemented method of claim 42, further comprising:
receiving, through a computer interface, a geographic location;
accessing, within a location database, information relating to temperature data at the geographic location; and
calculating the predicted surface temperature of the physical object based at least in part on the first total solar reflectance value associated with the first coating and the temperature data at the geographic location.

44. The computer-implemented method of claim 42, further comprising:
receiving, through a computer interface, a current weather condition including temperature data of a geographic location wherein a physical object is located;
receiving, through the computer interface, information about a first coating that is currently on the physical object;
retrieving from the coating database a first total solar reflectance value for the first coating; and
calculating the heat map of the physical object based at least in part on the first total solar reflectance value associated with the first coating and a current temperature.

45. The computer-implemented method of claim 42, wherein the computer display comprises a head-mounted display.

46. The computer-implemented method of claim 45, further comprising:
receiving, through a camera integrated into the head-mounted display, an image of a physical object;
receiving, through the computer interface, a current weather condition including temperature data of a geographic location wherein the physical object is located;
receiving, through the computer interface, information about a first coating that is currently on the physical object;
retrieve from the coating database a first total solar reflectance value for the first coating;
calculating a heat map of the physical object based at least in part on the first total solar reflectance value associated with the first coating and a current temperature; and
rendering, within the head-mounted display, the heat map of the first coating or color selected from the one or more coatings on a physical object, wherein the heat map is overlaid on the image of the physical object.

47. A non-transitory computer-readable medium comprising one or more physical computer-readable storage media having stored thereon computer-executable instructions that, when executed at a processor, cause a computer system to perform a method for mapping total solar reflectance to coatings, the method comprising:
receiving, through a computer interface, a set of color coordinates from a coating;
searching a coating database for one or more coatings that conform with the set of color coordinates;
retrieving from the coating database in association with each of the one or more coatings one or more respective total solar reflectance values for each coating; and
rendering, on a computer display, at least one of the one or more coatings and visual information relating to the total solar reflectance for the at least one of the one or more coatings.
